(19) United States
(12) Patent Application Publication
(10) Pub. No.: US 2020/0063598 A1
(43) Pub. Date: Feb. 27, 2020

(54) Turbogenerator Rotor Lock

(71) Applicant: Bowman Power Group Limited, Southhampton (GB)

(72) Inventors: Robert Fallon, Southhampton (GB); James Smith, Southhampton (GB); Shinri Szymko, Southhampton (GB)

(21) Appl. No.: 16/498,212

(22) PCT Filed: Mar. 21, 2018
(86) PCT No.: PCT/GB2018/050730

§ 371 Date: Sep. 26, 2019

(30) Foreign Application Priority Data
Mar. 27, 2017 (GB) 1704838.0

(51) Int. Cl. F01D 21/00

(52) U.S. Cl. CPC F01D 21/006; F05D 2260/30

(57) ABSTRACT

A turbogenerator rotor lock (1) is described, the turbogenerator rotor lock (1) including a head portion (10) and a locking portion (20, 21), wherein the locking portion (20,21) extends from the head portion (10) to engage with a turbogenerator rotor to prevent its rotation. In this way, a simplified apparatus for locking a turbogenerator rotor in position is provided, allowing the prime mover to continue operation in the event of a turbogenerator system (1000) failure

### FIELD OF THE INVENTION

The present invention relates to a turbogenerator rotor lock, and more particularly to a turbogenerator rotor lock comprising a head portion and a locking portion.

### BACKGROUND TO THE INVENTION

Turbogenerator energy recovery systems (ERS) are often fitted to engines or other industrial apparatus to increase the overall energy efficiency of a machine plant or manufacturing process. In these industrial settings, ERS are most usually installed to recover waste energy from a prime mover, for example from the exhaust gases of a reciprocating engine.

Where an ERS is installed in combination with a prime mover, it is often the operation of the prime mover that takes precedence over the operation of the ERS. Where these technologies are installed in tandem, any disruption to the operation of the prime mover may result in the complete shutdown of all associated activities. Any such shutdown may have large cost implications. On the other hand, shutdown of the ERS, while inconvenient, may usually be overcome with an increased reliance on the electrical grid, or on alternative power sources.

Therefore, a prime mover and ERS are installed in combination, it often important that any faults on the ERS have minimal effect on the operation of the prime mover. In the state of the art, the ERS is bypassed when a fault is detected, enabling operation of the prime mover to continue unhindered.

In the most advanced systems, valves are used to allow fluids or gases from the prime mover to bypass the ERS whenever a fault is detected. The operation of the valves may be automatic whenever a fault is detected with the ERS, allowing the unhindered operation of the prime mover. However, such systems are expensive, and often require highly trained operatives to install and maintain the valves. Therefore, the installation and maintenance of a bypass valve system can be prohibitively expensive, except on the largest prime mover systems.

At the other end of the scale, in the event of an ERS failure, the simplest bypass technology may be used to replace the ERS and may involve the use of a separate dummy pipe which may be attached to the prime mover to replicate the flow path through the. Whilst such a system is technologically very simple, installation of the dummy pipe frequently requires significant, disruptive work on the prime mover system. Any such work often requires the operation of the prime mover to cease, resulting in increased costs and reduced productivity. Additionally, the dummy pipework is frequently large and bulky, such that its storage represents a significant inconvenience.

With the above points in mind, there is desire for a technology that allows the operation of the prime mover to be resumed both cost effectively and rapidly after a fault in an associated ERS system is detected.

### SUMMARY OF THE INVENTION

According to a first aspect of the present invention, there is provided a turbogenerator rotor lock, said turbogenerator rotor lock comprising; a head portion, and at least one locking portion, wherein, in use, said at least one locking portion extends from said head portion to engage with a turbogenerator rotor to prevent its rotation.

Use of a turbogenerator rotor lock in this form reduces the time any prime mover must remain inoperative due to a fault with, or repair of, a turbogenerator system. Additionally, any such turbogenerator rotor lock may be easily installed without the use of a specialised mechanic, or the use of proprietary tools, further reducing the costs of turbogenerator system maintenance and repair.

Preferably, the head portion comprises at least one screw thread. More preferably, this screw thread is located at a perimeter of the head portion. Still more preferably, the screw thread extends around the entirety of a perimeter of the head portion.

Preferably, the locking portion comprises at least one flat or domed surface. More preferably, the flat surface has a normal perpendicular to the longitudinal axis of the turbogenerator rotor lock. Still more preferably, the flat surface is positioned such that the normal to this surface points towards the central longitudinal axis of the turbogenerator rotor lock.

Preferably, a cross section of the locking portion comprises a geometric shape. More preferably, a cross section of the locking portion comprises a polygon. Preferably, the cross-sectional shape of the locking portion is continuous throughout the length of the locking portion.

Preferably, the locking portion extends perpendicularly from a surface of said head portion. Preferably, the locking portion extends from the head portion in an area proximate a screw thread on the head portion.

Preferably, the locking portion extends from a surface of the head portion at a position away from the centre of said surface.

Preferably, the locking portion extends from a surface of the head portion at the perimeter of said surface. More preferably, the locking portion extends around the entire perimeter of said surface. Still more preferably, the locking portion extends continuously around the entire perimeter of said surface.

Preferably, the locking portion extends from the head portion in a direction parallel to the central longitudinal axis of the turbogenerator rotor lock. More preferably, the locking portion extends from the head portion along the central longitudinal axis of the turbogenerator rotor lock.

Preferably, the rotor lock comprises a plurality of locking portions. Preferably, the locking portions are equally spaced around the circumference of said head portion. More preferably, the locking portions are spaced symmetrically around the circumference of said head portion.

Preferably, at least two locking portions are substantially opposite one another. Preferably, the plurality of locking portions extend from the head portion along parallel axes.

Preferably, the head portion has a substantially circular cross section. Preferably, the head portion is bevelled or chamfered. Preferably, the head portion comprises at least one flat, and more preferably comprises a plurality of flats.

According to a second aspect of the present invention, there is provided a method of locking the rotation of a rotor within a turbogenerator system, the method comprising the insertion of a turbogenerator rotation lock as described in this application into a turbogenerator system, wherein said turbogenerator rotation lock engages with a rotor of the turbogenerator system to prevent its rotation.

A method of this form assists in the rapid and cost effective immobilisation of turbogenerator rotor after a fault is detected, or for routine maintenance.

Preferably, the insertion of the turbogenerator rotation lock into the turbogenerator system comprises rotating the turbogenerator rotation lock. More preferably, the turbogenerator rotation lock is inserted into said turbogenerator system via a screw thread.

Preferably, a blanking member is removed from a location on the turbogenerator system, before the turbogenerator rotation lock is inserted into the turbogenerator system proximate, or at, said location.

According to a third aspect of the present invention, there is provided a turbogenerator system, comprising a turbogenerator rotor lock as described in the present application, and a rotor shaft, the rotor shaft comprising an engagement structure at one end, wherein the locking portion of the turbogenerator rotor lock is sized to engage with the engagement structure of the rotor shaft to prevent the rotor shaft from rotating within the turbogenerator.

### DETAILED DESCRIPTION

Embodiments of the present invention will now be described by way of example only and with reference to the accompanying drawings, in which:

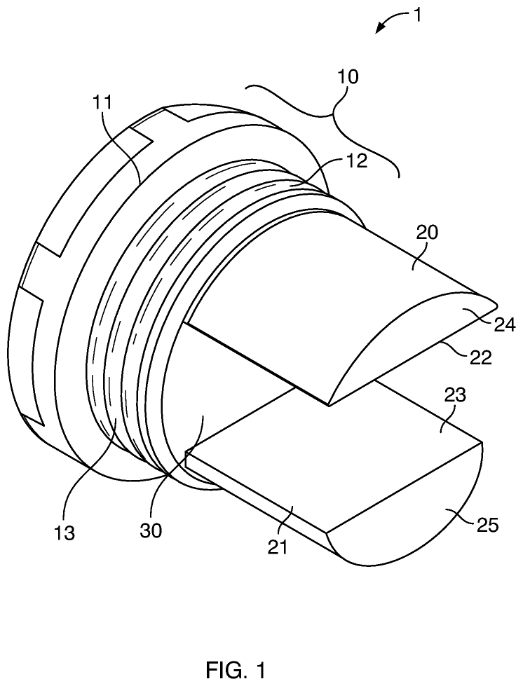

FIG. 1 is a schematic view of a first embodiment of a turbogenerator rotor lock in accordance with the present invention;

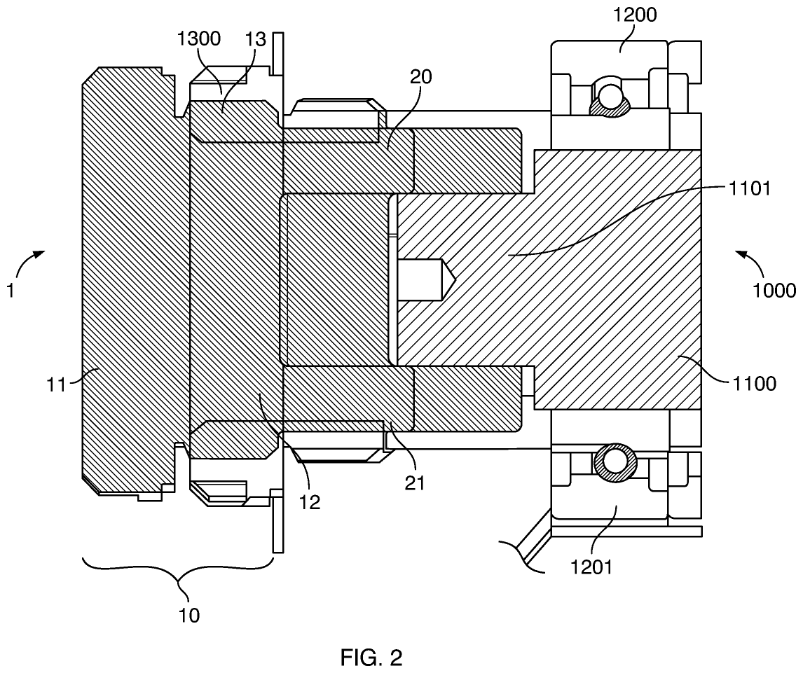

FIG. 2 is a cross sectional view of a turbogenerator rotor lock in accordance with the present invention inserted into a turbogenerator system to engage a rotor; and

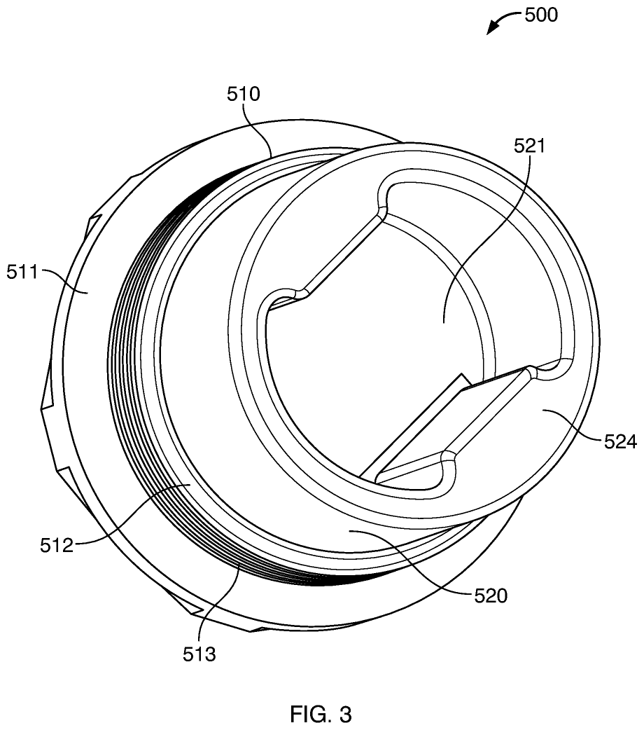

FIG. 3 is a schematic view of a second embodiment of a turbogenerator rotor lock in accordance with the present invention.

Referring to FIG. 1 of the drawings, there is shown a turbogenerator rotor lock 1 in accordance with the present invention. Here, the turbogenerator rotor lock 1 comprises a head portion 10 and first 20 and second 21 locking portions. The head portion 10 comprises a first section 11 and a second section 12, both first 11 and second 12 sections comprising a substantially circular cross section.

The first section 11 extends from a first end to a second end, throughout which the cross section of the first section 11 is substantially uniform. The second end of the first section 11 is adjacent and connected to a first end of the second section 12, the second section 12 also extending from this first end to a second end. Whilst both the first 11 and second 12 sections comprise a substantially circular cross section, the cross section of the first section 11 is larger than that of the second section 12. As such, the second section 12 extends as a cylinder from the first section 11.

The first end of the first section 11 comprises bevels, chamfers or flats around its perimeter, enabling the head portion 10 to be effectively gripped by a tool such as a spanner or a wrench. Additionally, the second section 12 of the head portion 10 comprises a screw thread 13 around its perimeter, enabling the turbogenerator rotor lock 1 to be screwed into an aperture on a turbogenerator.

Each of the locking portions 20, 21 extends perpendicularly from the second end of the second section 12 of the head portion 10 with a continuous semi-circular cross section, such that each first 20 and second 21 locking portion includes both a planar face 22, 23 and a curved face. The first 20 and second 21 locking portions are positioned such that their planar faces 22, 23 are substantially opposite one another, and such that their planar faces 22, 23 are positioned towards the central longitudinal axis of the turbogenerator rotor lock 1.

The planar faces 22, 23 of the first 20 and second 21 locking portions define a channel 30 which extends perpendicular to the central longitudinal axis of the turbogenerator rotor lock 1. As such, the second end of the second section 12 of the head portion 10, the planar face 22 of the first locking portion 20 and the planar face 23 of the second locking portion 21 each define a side of the channel 30.

Both the first locking portion 20 and the second locking portion 21 terminate in end faces 24, 25. The end face 24 of the first locking portion 20 and the end face 25 of the second locking portion 21 are located at the same distance from the head portion 10. Both end faces 24, 25 are substantially planar. Both end faces 24, 25 are semi-circular in shape.

The edges of the first 20 and second 21 locking portions remain within the confines of a cylinder defined by the outer perimeter of the second section 12 of the head portion 10, this cylinder extending along the central longitudinal axis of the turbogenerator rotor lock 1. As such, the locking portions 20, 21 are sized to fit within the diameter of any aperture with which the screw thread 13 may engage.

In this embodiment of the invention, the turbogenerator rotor lock 1 comprises a metal such as steel or aluminium.

Referring now to FIG. 2, the relationship between the turbogenerator rotor lock 1 and a turbogenerator 1000 can be seen in more detail. Here, the first 20 and second 21 locking portions have been inserted into the turbogenerator system 1000 such that they engage with the shaft 1100 of the turbogenerator rotor. The shaft 1100 is supported by a bearing structures 1200, 1201 within the turbogenerator system 1000 such that the shaft 1100 may freely rotate.

To install the turbogenerator rotor lock 1, the first 20 and second 21 locking portions are inserted into an aperture in the turbogenerator system 1000. This insertion may occur after a blanking plug (not shown) is removed from the aperture. The first 20 and second 21 locking portions of the turbogenerator rotor lock 1 engage with a stepped end 1101 of the shaft 1100 upon their insertion into the aperture, as the first 20 and second 21 locking portions are sized to fit or interact with the profile of the stepped end 1101 of the shaft 1100.

Subsequently, the screw thread 13 of the second section 12 of the head portion 10 engages with a complimentary screw thread 1300 located at the perimeter of the aperture. The turbogenerator rotor lock 1 is then tighten into the aperture such that it is secured in place by the interaction of the screw threads 13 and 1300. A user undertakes this tightening process, by hand or with the use of tools on the first section 11 of the head portion 10.

After a period of tightening, the screw threads 13 and 1300 locate the turbogenerator rotor lock 1 in position such that the turbogenerator rotor lock 1 is secure. At this point, further tightening of the turbogenerator rotor lock 1 becomes difficult or impossible. As the rotation of the turbogenerator rotor lock 1 is coupled to the rotation of the shaft 1100, by virtue of the interaction between the first 20 and second 21 locking portions and the stepped end 1101 of the shaft 1100, the shaft 1100 itself becomes unable to rotate. In this situation, the rotor is locked into position, and any user may maintain, or repair, the turbogenerator system 1000 or operate the prime mover whilst the rotor is locked.

After maintenance or repair of the turbogenerator system 1000 is complete, the turbogenerator rotor lock 1 may be removed from the turbogenerator system 1000 with a reversal of the installation procedure. As the turbogenerator rotor lock 1 is unscrewed from the turbogenerator system 1000, the first 20 and second 21 locking portions of the turbogenerator rotor lock 1 disengage from the stepped end 1101 of the shaft 1100, allowing the shaft 1100 to rotate freely and independently once again. After the turbogenerator rotor lock 1 has been fully removed from the turbogenerator system, any blanking plug may be reinserted into the aperture, restoring the turbogenerator system to full working order.

In this way, the maintenance of a turbogenerator system 1000 may be undertaken without significant disruption to the operation of the prime mover. The prime mover must be inactive during the installation and removal of the turbogenerator rotor lock 1, as engagement of the locking portions 20, 21 with the stepped end 1101 of the shaft 1100 whilst it is rapidly rotating or under load has a high probability of damaging the shaft 1100 and rotor. However, whilst the turbogenerator rotor lock 1 is in position, and the locking portions 20,21 are engaged with the stepped end, the prime mover may resume operation.

Operation of the prime mover when the turbogenerator rotor lock 1 is installed is possible as the rotor is prevented from moving under the influence of the prime mover, ensuring no damage, or further damage, will be caused to the turbogenerator system 1000 by the operation of the connected prime mover. Additionally, the head portion 10 of the turbogenerator rotor lock 1 blocks the aperture in the turbogenerator system 1000 from which the blanking plug was removed, ensuring the flow path through the turbogenerator system 1000 when the turbogenerator rotor lock 1 is installed remains similar to that experienced by the prime mover whilst the turbogenerator system 1000 is operational and the blanking plug is installed. This similarity is despite the absence of any rotation of the rotor, and assists in the effective and continued operation of the prime mover. Whilst the prime mover is operational, the forces exerted on the rotor and thus shaft 1100 are insufficient to result in the loosening of the turbogenerator rotor lock 1.

Overall, use of a turbogenerator rotor lock 1 reduces the time any prime mover must remain inoperative to the relatively brief periods during the installation and removal of the lock. As such, the time any prime mover is non-operational due to the repair or maintenance of a turbogenerator system is reduced, whilst the cost of implementation is low due to the simplicity of the technology and its ease of installation.

The second embodiment of the turbogenerator rotor lock 500 illustrated in FIG. 3 of the drawings comprises a head portion 510 and a locking portion 520. The head portion 510 comprises a first section 511 and a second section 512, both first 511 and second 512 sections comprising a substantially circular cross section.

The first section 511 extends from a first end to a second end, throughout which the cross section of the first section 511 is substantially uniform. The second end of the first section 511 is adjacent and connected to a first end of the second section 512, the second section 512 also extending from this first end to a second end. Whilst both the first 511 and second 512 sections comprise a substantially circular cross section, the cross section of the first section 511 is larger than that of the second section 512. As such, the second section 512 extends as a cylinder from the first section 511.

The first end of the first section 511 comprises bevels, chamfers or flats around its perimeter, enabling the head portion 510 to be effectively gripped by a tool such as a spanner or a wrench. Additionally, the second section 512 of the head portion 510 comprises a screw thread 513 around its perimeter, enabling the turbogenerator rotor lock 500 to be screwed into an aperture on a turbogenerator.

The locking portion 520 extends perpendicularly from the second end of the second section 512 of the head portion 510. The locking portion 520 extends continuously around the entire perimeter of the second section 512 of the head portion 510, and is shaped such that the locking portion 520 has a constant cross sectional area throughout its length.

The locking portion 520 comprises a slot or blind slit 521 at its centre. The blind slit itself comprises a central rectangular portion which extends across the central longitudinal axis of the turbogenerator rotor lock 500, and two generally semi-circular or kidney shaped portions located at opposite edges of the central rectangular portion. Together, the two kidney shaped portions and the central rectangular portion coincide to form a single blind slit 521. The walls of the kidney shaped portions and the central rectangular portion define the sides of the single blind slit 521.

The central longitudinal axis of the blind slit 521 is coaxial with the central longitudinal axis of the turbogenerator rotor lock 500. In use, the blind slit is sized to fit and receive the end of a rotor shaft 1100 to prevent the rotation of this rotor shaft during operation of an engine or any other prime mover.

The locking portion 520 terminates in an end face 524 which is substantially planar. The end face 524 forms a continuous ring at the end of the locking portion 520, and the transition between the end face 524 and the side walls of the locking portion 520 are rounded. Additionally, the transition between the end face 524 and the blind slit 521 is rounded or bevelled.

The edge of the locking portion 520 remains within the confines of a cylinder defined by the outer perimeter of the second section 512 of the head portion 510, this cylinder extending along the central longitudinal axis of the turbogenerator rotor lock 500. As such, the locking portion 520 is sized to fit within the diameter of any aperture with which the screw thread 513 may engage.

1. A turbogenerator rotor lock, said turbogenerator rotor lock comprising;
a head portion, and
at least one locking portion,
wherein, in use, said at least one locking portion extends from said head portion to engage with a turbogenerator rotor to prevent its rotation.

2. A turbogenerator rotor lock according to claim 1, wherein said head portion comprises at least one screw thread.

3. A turbogenerator rotor lock according to claim 1 or claim 2, wherein said locking portion comprises at least one flat or domed surface.

4. A turbogenerator rotor lock according to any preceding claim, wherein a cross section of said locking portion comprises a geometric shape.

5. A turbogenerator rotor lock according to any preceding claim, wherein a cross section of said locking portion comprises a polygon.

6. A turbogenerator rotor lock according to any preceding claim, wherein said locking portion extends perpendicularly from a surface of said head portion.

7. A turbogenerator rotor lock according to any preceding claim, wherein said locking portion extends from a surface of said head portion at a position away from the centre of said surface.

8. A turbogenerator rotor lock according to any preceding claim, wherein said locking portion extends from a surface of said head portion at the perimeter of said surface.

9. A turbogenerator rotor lock according to claim 8, wherein said locking portion extends around the entire perimeter of said surface.

10. A turbogenerator rotor lock according to claim 9, wherein said locking portion extends continuously around the entire perimeter of said surface.

11. A turbogenerator rotor lock according to any preceding claim, wherein said locking portion extends from said head portion in a direction parallel to the central longitudinal axis of said turbogenerator rotor lock.

12. A turbogenerator rotor lock according to any preceding claim, wherein said rotor lock comprises a plurality of locking portions.

13. A turbogenerator rotor lock according to claim 12, wherein said locking portions are equally spaced around the circumference of said head portion.

14. A turbogenerator rotor lock according to claim 12 or claim 13, wherein said locking portions are spaced symmetrically or evenly around the circumference of said head portion.

15. A turbogenerator rotor lock according to any one of claim 12, 13 or 14, wherein at least two locking portions are substantially opposite one another.

16. A turbogenerator rotor lock according to any one of claims 12 to 15, wherein said plurality of locking portions extend from said head portion along parallel axes.

17. A turbogenerator rotor lock according to any preceding claim, wherein said head portion has a substantially circular cross section.

18. A turbogenerator rotor lock according to any preceding claim, wherein said head portion is bevelled or chamfered or comprises flats.

19. A method of locking the rotation of a rotor within a turbogenerator system, the method comprising the insertion of a turbogenerator rotor lock as claimed in any preceding claim into a turbogenerator system, wherein said turbogenerator rotor lock engages with a rotor of the turbogenerator system to prevent its rotation.

20. A method according to claim 19, wherein the insertion of said turbogenerator rotor lock into said turbogenerator system comprises rotating said turbogenerator rotor lock.

21. A method according to claim 20, wherein said turbogenerator rotor lock is inserted into said turbogenerator system via a screw thread.

22. A method according to claim 19, claim 20 or claim 21, where a blanking member is removed from a location on said turbogenerator system, before said turbogenerator rotor lock is inserted into said turbogenerator system proximate, or at, said location.

23. A turbogenerator system, said turbogenerator system comprising; a turbogenerator rotor lock as claimed in any one of claims 1 to 18, and
a rotor shaft, said rotor shaft comprising an engagement structure at one end, wherein said locking portion of said turbogenerator rotor lock is sized to engage with said engagement structure of said rotor shaft to prevent said rotor shaft from rotating within said turbogenerator.
